(19) United States
(12) Patent Application Publication
(10) Pub. No.: US 2007/0169150 A1
(43) Pub. Date: Jul. 19, 2007

(54) Automated signal selection

(75) Inventor: David J. Woolgar, Horsham (GB)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., EINDHOVEN (NL)

(21) Appl. No.: 10/596,442

(22) PCT Filed: Dec. 13, 2004
(86) PCT No.: PCT/IB04/52780

§ 371 Date: Jun. 14, 2006

(30) Foreign Application Priority Data
Dec. 17, 2003 (EP) 0329202.6

(51) Int. Cl. G06F 3/00; H04N 7/173; G06F 13/00; H04N 5/445

(52) U.S. Cl. 725/60; 725/86; 725/87

(57) ABSTRACT

A method and system for selecting a signal from a plurality of signals received by a component in an AV system. An identifier is added (106) to a signal in dependence on the signal being generated by an active component of the system. For each received signal containing an identifier, one or more parameters of the identifier are determined (116), such as the start time when the component became active, or the address of the component. A signal is selected (124) from the plurality of signals received according to the determined parameters and optionally with reference to a relevant parameter such as component address sent via a separate communications channel.

The present invention relates to a method for selecting a signal from a plurality of signals, in particular the selection of AV signals within a consumer electronics (CE) home entertainment system.

In general a CE home entertainment system comprises a number of source products (referred to hereafter as components) typically centred around a presentation component such as a TV or audio receiver. The consumer has the problems of connecting each component of the system and then configuring the system to ensure that a specified source is correctly rendered on the desired presentation component. An automatic solution to these problems is desirable.

The Scart (Syndicat des Constructeurs d'Appareils Radiorécepteurs et Televiseurs) connection method for CE components (as specified in IEC Standard 60933-1) supports an automated method of signal selection which utilises a signal designated Function Switching, the operation of which is defined in European Standard “Domestic and similar Electronic Equipment interconnection requirements: Peritelevision connector”, EN 50049-1:1997 at Table 1. For a television receiver, the Function Switching signal is a control voltage applied as an input signal delivered by peripheral equipment connected to the television receiver using a Scart connection. When the Function Switching signal is asserted, the television receiver performs reproduction of a source connected to the Scart in place of television broadcast reproduction. A disadvantage of the method is that it requires the use of Scart interconnection; significant markets, such as the USA and Japan, do not utilise Scart interconnection for home entertainment systems and therefore do not benefit from the method. Furthermore, even for Scart connected systems, non-Scart interconnections, for example for digital audio, are also becoming necessary. Such connections are however not supported by the method. A further disadvantage is that the method utilises a dedicated signal conductor.

It is an object of the present invention to improve on the known art.

In accordance with the present invention there is provided a method for selecting a signal from a plurality of signals received by a component in an AV system comprising:
adding an identifier to a signal in dependence on the signal being generated by an active first component;
sending the signal from the active first component;
receiving a plurality of signals at a second component;
for each signal of the plurality of received signals:
   analysing the signal for the presence of the identifier; and
   where the identifier is present determining and storing at least one parameter associated with the identifier; and
selecting a signal from the plurality of received signals in dependence on stored ones of the parameters.

An active component is a component which is currently selected to provide one or more AV signals (content) within a system of components. Advantageously, a signal in an AV system, such as a video or audio signal, has an identifier added in dependence on the signal being generated by an active first component. Therefore, the sending of the signal from a first component to a second component is sufficient to establish that the connection is made and to identify to the second component that he first component is active. It is to be noted that the method is thus independent of any specific connection method, such as Scart, and furthermore is suitable for wired interconnection, for example RCA (phono) jacks, Scart, RF coaxial, IEEE1394, optical or wireless interconnection, for example WiFi, HiperLAN, IEEE802.11, IrDA.

Furthermore, the identifier might be continually added to the signal in dependence on the signal being generated by an active component; preferably, the identifier is temporarily added to the signal in dependence on the signal being generated by an active component, for example being added at the commencement of the relevant component becoming active. Advantageously, the identifier is added to the signal by means of time division multiplexing. This method of addition is both compatible with a wide range of signals and also with a source component becoming active when a short period of interruption/change in the associated signal is acceptable. An identifier can comprise one or more of the following: a DC voltage, frequency tone or digital data. An example identifier comprises a frequency tone. Preferably, the tone is inaudible when added to an audio signal but also is able to be decoded using a modest processing means within a component; suitably the identifier comprises at least one frequency component in the range 20 kHz to 500 kHz. Preferably, the identifier comprises a frequency component of 22 kHz.

The identifier added to a signal may comprise a substantially constant parameter. In the above example, the frequency tone for example may comprise a burst of pre-determined time duration. An identifier may further comprise at least one parameter which is related to the time of commencement of the first component becoming active; for example the time of commencement of the tone burst. At the second component, a signal may be selected based on the most recent time of commencement.

Alternatively, or in addition, the identifier may convey additional information, for example digital data, using any suitable method known in the art. Advantageously, the digital data may be embedded in the above described tone burst of pre-determined time duration, for example by modulating the tone burst using amplitude, frequency or phase modulation. Preferably, amplitude modulation using on-off keying (OOK) is employed. It is to be noted that such an identifier is suitable for adding to any video and/or audio signal, whether coded in analogue or digital format.

Additionally, or alternatively, where the signal is digital, the identifier may be added to the signal by using an available data payload capacity of the signal, for example the user bits of SP/DIF. In this case, a suitable protocol could be determined to indicate the presence of the identifier and possibly also a parameter such as the time of commencement. Any such protocol is readily determinable by the skilled person.

Optionally, the method is further enhanced by communicating to other components of the system a relevant parameter associated with the identifier. This relevant parameter is in turn acquired by the second component and selection of a signal from the plurality of received signals is made on the basis of a comparison of stored ones of the parameters and the relevant parameter.

Advantageously, this enhancement of the method enables a component receiving a plurality of signals to associate, without any prior configuration; one or more of those signals with a specified active component. A component of the system can configure itself using the identity of the specified active component to forward (to another component) or process the relevant signals (for example to select the best quality signals available) irrespective of the means or arrangement of connection employed to apply those signals to the component. For example, in one embodiment an audio receiver automatically renders the digital audio signal corresponding to a specified active component applied to any digital audio input of the receiver in preference to rendering an analogue audio signal (from the same component) applied to any Scart and/or RCA (phono) jack input of the receiver. The active component can be specified by the relevant parameter, for example the relevant parameter comprises an address of the active component. Preferably, the component addresses conform to the Project50 standard. Furthermore, preferably, the relevant parameter is communicated to other components of the system by means of a communications bus, for example Project50 protocol over Scart, or CEC protocol over HDMI.

According to a further aspect of the present invention there is provided an AV system comprising at least a first component connected to a second component by a connection means, wherein the first component is operable to:
add an identifier to a signal in dependence on the first component being active;
send the signal to the second component; and wherein the second component is operable to:
receive from at least one first component a plurality of signals;
for each signal of the plurality of received signals:
   analyse the signal for the presence of the identifier; and
   where the identifier is present determine and store at least one parameter associated with the identifier; and
select a signal from the plurality of received signals in dependence on stored ones of the parameters.

Optionally, the first component also communicates to other components of the system a relevant parameter associated with the identifier; and the second component acquires the relevant parameter and selects a signal from the plurality of received signals on the basis of a comparison of stored ones of the parameters and the relevant parameter.

The connection means may comprise a bus to support the communication of the relevant parameter, such as Scart pin 10 or HDMI carrying the relevant parameter using the Project50 or CEC protocol respectively. The present invention supports any type of analogue or digital signal connection to an AV component within an AV system irrespective of connection means employed (for example Scart, RCA (phono) jacks, etc.). Configuration of system components to route and/or render AV signals is automatic, and may also offer the ability to give priority to the best quality signals. Where indication of a specific active component is further provided, this allows explicit identification of signals originating from that component.

Embodiments of the invention will now be described, by way of example only, with reference to the accompanying drawings in which:

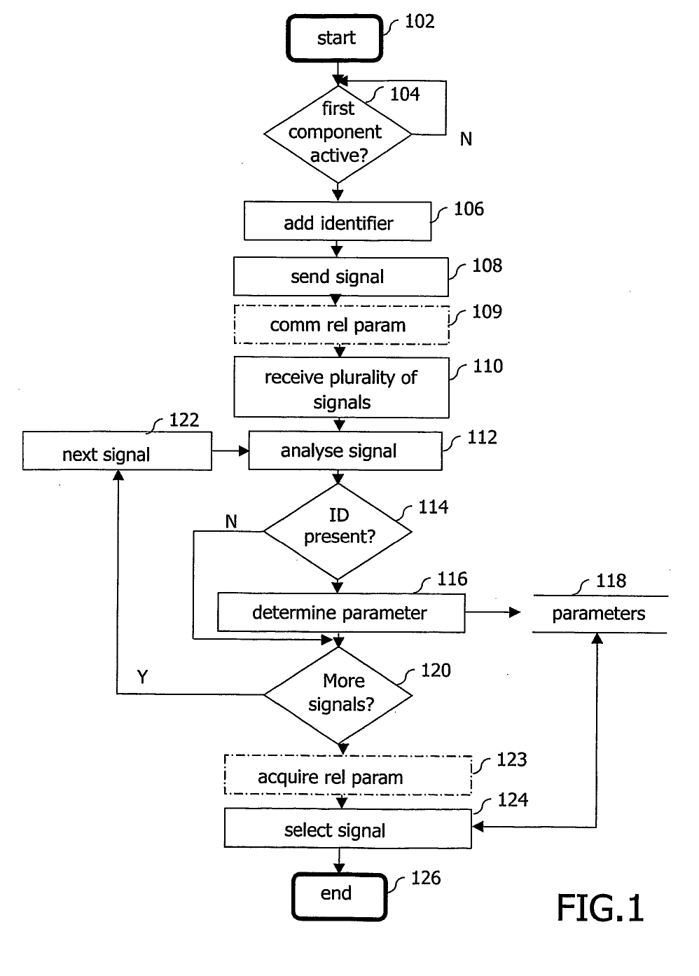

FIG. 1 is a flowchart of a method for selecting a signal from a plurality of signals received by a component in an AV system;

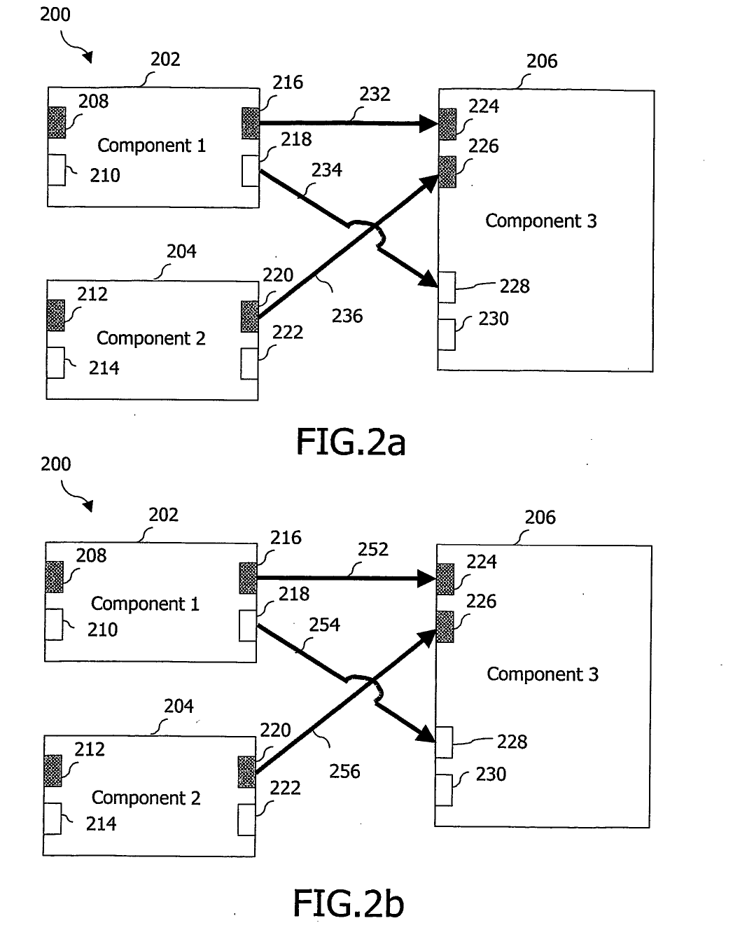

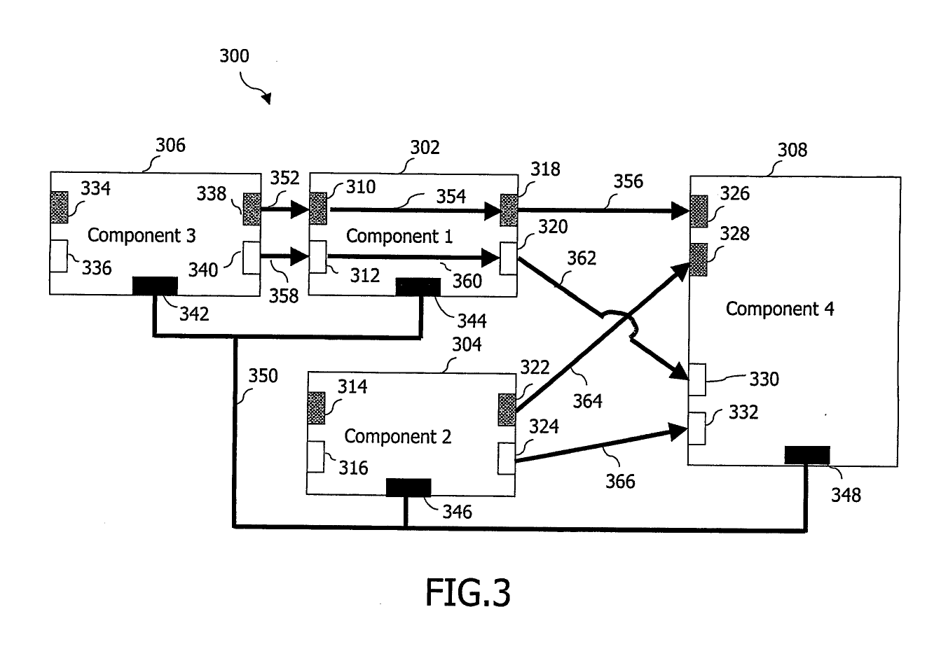

FIGS. 2a, 2b and 3 are schematic diagrams of AV systems; and

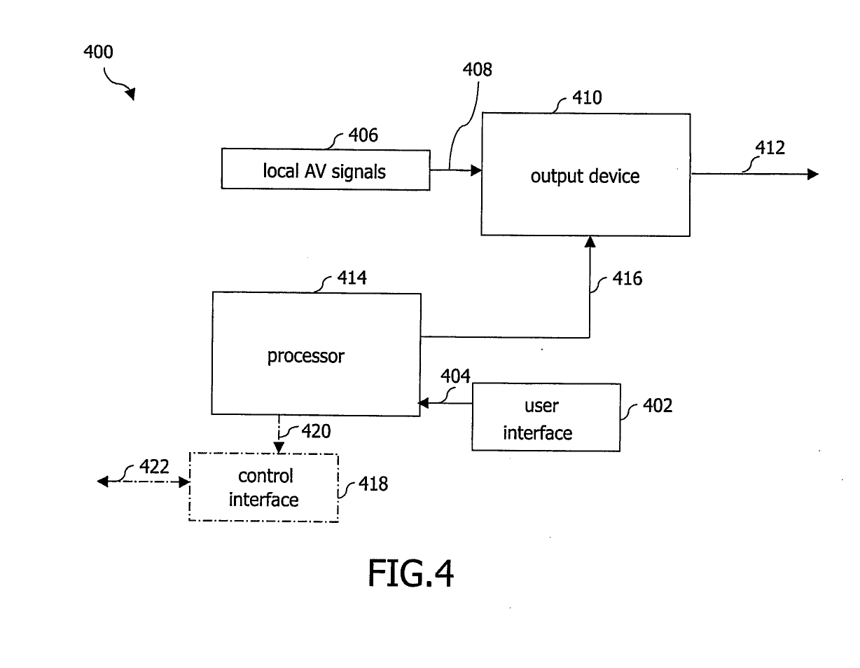

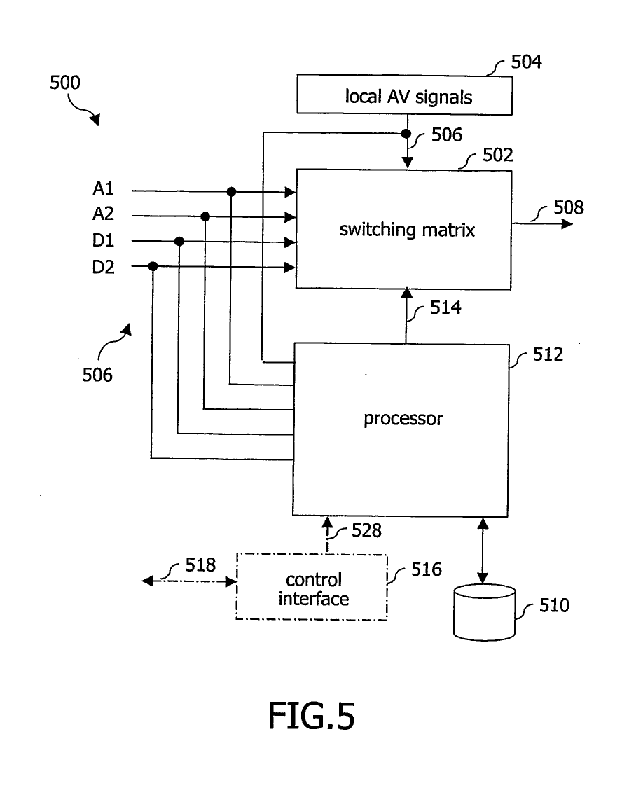

FIGS. 4 and 5 are schematic diagrams of components for use in any of the systems of FIGS. 2a, 2b and 3.

FIG. 1 shows a flowchart of a method for selecting a signal from a plurality of signals received by a component in an AV system. The method starts at 102 and then determines 104 if a first component is active. If this is the case, an identifier is added 106 to the signal generated by the active first component. For example, where the active first component is a DVD player, an identifier is added to at least one output signal of the player, such as one or more of the video or audio outputs, irrespective of whether they are digital or analogue. The identifier can comprise one or more of the following: a DC voltage, a tone signal or digital data. Similarly, the identifier may be added for. a part or the entire duration of the time period in which the first component is active. Advantageously, the design of products such as TVs which utilise the Function Switching feature of EN 50049-1:1997 could be enhanced by including an interface to couple the identifier to the existing Function Switching circuitry thereby enabling a non-Scart AV input (that is, an input which does not include a separate Function Switching signal conductor) to also effect Function Switching. In a preferred embodiment, the identifier is a tone burst added to the signal at the commencement of the first component becoming active, for example in the range 20 kHz-500 kHz; preferably a tone of 22kHz with duration 200 ms. Such a tone is inaudible when used with audio signals. As a further enhancement, the tone burst can be modulated to carry digital data; preferably, a tone of 22 kHz of duration 200 ms is on-off keyed to carry at least 16 bits of information. In the event the signal is digital, a digital identifier can be added, for example using the user bits of an audio SP/DIF signal.

Once the identifier is added, the signal is sent 108 to another component. The method then comprises an optional step (as shown in dashed outline in FIG. 1) of communicating 109 to other components of the system a relevant parameter associated with the identifier. In a preferred embodiment, the relevant parameter is the component address of the active component and is communicated to other components of the system using Project50; the identifier added to the signal also comprises the same component address. Such addresses preferably conform to the Project50 standard. Other components of the system are then able to configure themselves to forward or render signals of which the identifier comprises the corresponding address. Another relevant parameter of the identifier includes the commencement time of the associated component becoming active.

For the method, the sent signal, possibly along with signals from the same and/or other components, is received 110. Each received signal is then analysed 112 to determine 114 the presence of an identifier; if an identifier is present a parameter associated with the identifier is determined 116 and stored 118. Where more signals 120 remain to be analysed, these are selected in turn 122. As discussed above, such parameters can include the time when the presence of the identifier was first determined and/or a component address. Optionally (shown in dashed outline in FIG. 1), the method acquires 123 the relevant parameter, if any, associated with the identifier. A signal is then selected 124 with reference to at least the stored parameters 118. For example, where the parameters comprise the times when the presence of the identifier was first determined in each respective signal, then the signal is preferably selected according to the last (latest) time, since this is likely to correspond a component which is most recently made active. This includes the case where there is only one time stored: in this case only one component is currently active and the signal containing the identifier whose parameter comprised that time is therefore selected. In contrast, a signal can be selected based on a comparison of the stored parameters and acquired relevant parameter. This could comprise matching the acquired parameter to the times when the presence of the identifier was first determined in each respective signal and/or to the component address of each respective signal. In a preferred embodiment, the latter arrangement is used. The method ends at 126.

FIG. 2a shows an AV system 200 comprising Component 1, 202, Component 2, 204, and Component 3, 206. Component 1 and Component 2 represent CE entertainment products such as VCR, DVD, CD, set-top-box, etc. capable of providing AV signals in analogue and/or digital formats to other components of the AV system. Component 3 could be a TV or audio receiver or any component which is required to select an AV signal from a number of such signals. In the illustrated example, Component 1 comprises input connection 208 for analogue signals and input connection 210 for digital signals, which connections are unused. Similarly, Component 2 comprises input connection 212 for analogue signals and input connection 214 for digital signals, which connections are unused. Component 1 also comprises output connection 216 for sending analogue signal 232 to analogue input connection 224 of Component 3 206. Furthermore, Component 1 also comprises output connection 218 for sending digital signal 234 to digital input connection 228 of Component 3 206. Component 2 also comprises output connection 220 for sending analogue signal 236 to analogue input connection 226 of Component 3 206; digital output connection 222 of Component 2 204 is unused in the illustrated example. Component 3 206 is required to select a signal from signals 232, 234 and 236.

In the following discussion it is assumed that an identifier comprising a tone burst is added to the signals 232, 234, 236 at the relevant times. From the earlier discussion, a change in DC level or other suitable identifier could instead be added to the signals. The tone is preferably 22 kHz and a few hundred milliseconds in duration since this is inaudible when applied to analogue audio channels and can be modulated as and when required to carry a number of data bits, as discussed further below.

FIG. 2a will now be used to illustrate a number of scenarios. A component is made active by an event in the system, for example a user invoking Play on a VCR, DVD, etc. or perhaps selecting a new AV channel (e.g. broadcast TV station) to be presented. The mechanism to make a component active is outside the scope of the present description. It is to be noted that more than one component can be active simultaneously; certain embodiments are able to resolve which component (signal) to select in such a circumstance, as described later. In a first scenario, Component 2 is the only active component. Component 2 204 adds an identifier (in this example, a 22 kHz tone burst) to analogue signal 236 and sends the signal via its output connection 220 to analogue input connection 226 of Component 3. The connection between components of an AV system may be any suitable connection used for AV signals including one or more of wired and wireless methods. Examples of wired methods include Scart, RCA (phono) jacks, 6.25 mm jacks, 3.5 mm jacks and the like. Examples of wireless methods include IEEE802.11, low power radio at 868 MHz/915 MHz, WiFi, Bluetooth, IrDA infrared and the like. Furthermore, the AV signal to which the tone burst is added can be video, audio, graphic or textual information encoded in any analogue or digital format or formats; advantageously, the tone burst is added using time division multiplexing allowing compatibility with any signal type. In the example analogue audio is output from connection 220 and connections 220 and 226 are connected using RCA (phono) jacks. In Component 3 206, the signal (if any) at each input connection 224, 226, 228, 230 is analysed (by a processor) for the presence of an identifier, in this case a tone burst added to signal 236, and the processor then determines and stores at least one parameter associated with the identifier, in this case the start time of the tone burst. Other possible parameters might include digital information, of which see discussion in relation to FIG. 2b below. The start time can be relative to a suitable time reference, typically an internal Umer/clock of Component 3. Finally, the processor of Component 3 selects a signal from the plurality of received signals 232, 234, 236 in dependence on the stored parameters; in this simple example, there is only one signal 236 which has an identifier and so processor selects signal 236 without performing any comparison.

To illustrate a further scenario, sometime later (that is, while Component 2 is still active), Component 1 202 becomes active. Component 1 202 adds, substantially simultaneously, a tone burst to its AV output signals 232 and 234. Signal 232 is analogue, for example composite video whilst signal 234 is digital, for example an SP/DIF audio stream. In this case, Component 3 206 receives signals 232 and 234 at its inputs 224 and 228 respectively. As before, the processor of Component 3 analyses each received signal 232, 234 and 236 for the presence of an identifier. In this case, each signal contains an identifier (that is, a tone burst) and the processor determines and stores the respective start time of the tone burst of each received signal. It then selects a signal by comparing the stored parameters (in this example, start times). Typically, the selected signal is the signal with the latest occurring start time. Usually, only one signal would have a the latest occurring start time. However in this case both signals 232 and 234 (from Component 1) have essentially the same latest occurring start time, since the tone bursts of these respective signals were added substantially simultaneously. Component 3 then selects both signals 232 and 234 since these are, in this example, different (that is, 232 is video and 234 is audio). Where the signals are the same type (e.g. both video or both audio) and are not intended to be subsequently mixed, then Component 3 may elect to select one in preference to another. If in the present example signal 232 was analogue audio and signal 234 was digital audio, and wherein both have the same latest occurring tone burst start time, then Component 3 might select 234 in preference to 232 for quality reasons.

FIG. 2b shows the same system arrangement as FIG. 2a but in this case, signals 252, 254 and 256 comprise digital data contained within he identifier added to the respective signals. The digital data within the identifier may comprise header and/or framing code bits plus payload data, the latter being sufficient to convey a component address of at least 8 bits plus optionally additional information. Preferably at least 16 bits of payload capacity are provided. For analogue signals 252, 256, the identifier may comprise a baseband data burst time multiplexed with the signal. Preferably, a modulated tone burst is used, such as a 22 kHz tone in which the modulation used is on-off keying. This allows simple encoding and decoding whilst being inaudible when applied to an audio channel. For digital signal 254, the identifier may comprise a baseband data burst at the same or different rate to the data signal itself; or the identifier may comprise a modulated tone burst similar to that used for analogue signals. Alternatively, the identifier may comprise part of the payload of the host digital signal. In the present example of FIG. 2b, the identifier comprises a modulated tone burst for analogue signals 252 and 256 and comprises part of the payload of digital signal 254, for example the user bits of an audio SP/DIF signal; each identifier comprising a digital component address corresponding to the address of the originating component. As discussed earlier, in the case where Components 1 and 2 are simultaneously active (and where Component 1 was last to be made active), the processor of Component 3 206 analyses each received signal 252, 254 and 256. For each signal 252 and 256 the processor determines and stores the start time of the tone burst and also the component address; for signal 254, the processor only determines and stores the address, since tone burst was not applied to signal 254. Component 3 then selects signal 252 since this is has the latest start time; it then further checks the address determined from signal 252 with other addresses. In this case it finds signal 254 has the same address and selects signal 254 in addition to or instead of signal 252 in similar fashion as discussed in the equivalent scenario of FIG. 2a. An advantage of the present example is that an explicit association, by means of a common address, is made between signals 252 and 254, whereas in the example of FIG. 2a the association relied on the timing relationship of the identifiers (tone bursts) of the relevant signals.

FIG. 3 shows a system 300 comprising four components, namely Component 1 302, Component 2 304, Component 3 306 and Component 4 308. Analogue input connection 310 of Component 1 is connected to analogue output connection 338 of Component 3. Analogue input connection 326 of Component 4 is connected to analogue output connection 318 of Component 1. Analogue input connection 328 of Component 4 is connected to analogue output connection 322 of Component 2. Digital input connection 312 of Component 1 is connected to digital output connection 340 of Component 3. Digital input connection 330 of Component 4 is connected to digital output connection 320 of Component 1. Digital input connection 332 of Component 4 is connected to digital output connection 324 of Component 2. Furthermore, each component 302, 304, 306, 308 is connected to a control bus 350 via its respective control interface 344, 346, 342, 348. Inputs 314, 316 of Component 2 304 and 334, 336 of Component 3 306 are shown unused. Component 4 308 is required to select one or more signals from input signals 356, 362, 364, 366.

As an example, consider where Component 3 is made active and no other components are active. Component 3 306 adds an identifier comprising its component address to at least one (in this example, both) of its output signals 352, 358. Component 3 306 also communicates its component address to other components of the system via bus 350. Signals 352 and 358 are received at Component 1 302 which decodes the address of the identifier in each signal and compares it to the communicated component address received via bus 350; as the addresses match, Component 1 forwards (that is, selects in preference to other available signals such as internal signals, not shown in FIG. 4) and loops through the signals 354, 360 to be output (unmodified) as signals 356 and 362 respectively. Signals 356 and 362 are then received at Component 4 which also decodes the address of the identifier in each signal and compares it to the communicated component address received via bus 350; as the addresses match, Component 4 selects and subsequently processes the signals accordingly, for example presenting or storing the signals. In the system of FIG. 3, correct selection of the signals from the active component (Component 3, 306) is achieved by only determining addresses sent within the identifier added to the respective signals. Furthermore, the system would still function correctly in alternative connection configurations, for example, where signal 352 was connected directly to input 326 of Component 4 and signal 358 was connected to input 316 of Component 2 304. This independence of connection configuration also applies for the systems described in relation to FIGS. 2a and 2b.

That is, functioning of the systems described above is independent of specific signal interconnections or topology; it is sufficient that signal connections are made, since the method of the invention ensures that the correct signals are selected and routed within the AV system.

FIG. 4 shows a schematic diagram of an AV component 400 suitable for providing AV signals. The component comprises a user interface 402 such as a local keypad or remote control command receiver or other interface (such as a network interface) capable to receive user commands 404. On receipt of an appropriate command (for example a PLAY command in case the component is an AV content source device such as a disc player) the processor 414 determines that the component is now in an active state and instructs 416 an output device 410 to add an identifier to one or more AV signals 408, for example local signals 406 generated as a response to the PLAY command. The output device outputs the AV signals comprising the identifier 412. The added identifier may comprise a DC voltage pulse, tone burst, digital data embedded instream, or other suitable format. Optionally, as shown in dashed outline, the component may also comprise a control interface, 418; the processor instructing the control interface to communicate a relevant parameter 420 associated with the identifier via communication channel 422 to other components. Preferably the communication channel is Scart or HDMI using Project50 or CEC protocol respectively and the relevant parameter represents the Project50 source address.

FIG. 5 shows a schematic diagram of an AV component 500 suitable for selecting an AV signal from a number of received AV signals. A switching matrix 502 receives several AV signals 506, for example from a local source 504 (for example a broadcast tuner), analogue signal inputs A1, A2 and digital signal inputs D1, D2. A processor 512 analyses each of the received AV signals for the presence of an identifier and determines and stores in store 510 one or more parameters associated with the identifier, as discussed in detail earlier. The processor instructs 514 the switching matrix 502 to select one or more signals 508 according to the stored parameters, for example based on the latest occurring identifier. Optionally, the component receives a relevant parameter 528 associated with an identifier via communication channel 518 and control interface 516. The processor can then use the relevant parameter in the selection decision, for example by comparing the parameter with stored ones of the parameters. Preferably, the parameters are component addresses according to the Project50 protocol.

An example practical embodiment of the component of FIG. 5 is an AV receiver component. Analogue inputs A1 and A2 represent RCA (phono) jacks for analogue video (including any of CVBS, Y/C, RGB) and/or analogue audio inputs. Digital inputs D1, D2 represent digital video inputs (including MPEG2) and digital audio inputs (including any of SP/DIF, MP3). Connections may be made by any combination of wired and wireless means, as discussed earlier. Local AV signals 506 might be from an internal tuner, for example FM radio, internet provided AV content, and the like. The switching matrix in conventional receivers is configured by involvement of a user. By contrast, for a receiver embodying aspects of the present invention, a user simply has to connect other components of the system to signal type inputs A1 A2 D1 D2 (analogue and digital) discussed above, without needing to observe (configure) connecting a specific receiver input to a specific source component output. Preferably, the receiver is also connected to a Project50 bus via Scart or other suitable connection such as an RCA (phono) jack. Making a source component active then enables components of a suitably equipped AV system to route and/or render the relevant AV signals from the source component without further involvement of the user.

The foregoing method and implementations are presented by way of examples only and represent a selection of a range of methods and implementations that can readily be identified by a person skilled in the art to exploit the advantages of the present invention.

In the description above and with reference to FIG. 1, there is provided a method and system for selecting a signal from a plurality of signals received by a component in an AV system. An identifier is added 106 to a signal in dependence on the signal being generated by an active component of the system. For each received signal containing an identifier, one or more parameters of the identifier are determined 116, such as the start time when the component became active, or the address of the component. A signal is selected 124 from the plurality of signals received according to the determined parameters and optionally with reference to a relevant parameter such as component address sent via a separate communications channel.

1. A method for selecting a signal from a plurality of signals received by a component in an AV system comprising:
adding (106) an identifier to a signal in dependence on the signal being generated by an active first component;
sending (108) the signal from the active first component;
receiving (110) a plurality of signals at a second component;
for each signal of the plurality of received signals:
analysing (112) the signal for the presence of the identifier; and
where the identifier is present determining (116) and storing at least one parameter associated with the identifier; and
selecting (124) a signal from the plurality of received signals in dependence on stored ones of the parameters.

2. A method as claimed in claim 1 wherein the identifier comprises at least one frequency component in the range 20 kHz to 500 kHz.

3. A method as claimed in claim 2 wherein the identifier comprises a frequency component of 22 kHz.

4. A method as claimed in claim 1 wherein the at least one parameter comprises a value related to the time of commencement of the first component becoming active and where the signal is selected based on the most recent time of commencement.

5. A method as claimed in claim 1 further comprising, prior to the step of receiving, the step:
communicating (109) to other components of the system a relevant parameter associated with the identifier;
prior to the step of selecting, the step:
acquiring (123) the relevant parameter at the second component; and
wherein the step of selecting a signal from the plurality of received signals is on the basis of a comparison of stored ones of the parameters and the relevant parameter.

6. A method as claimed in claim 5 wherein the at least one parameter comprises a component address.

7. A method as claimed in claim 6 wherein the relevant parameter comprises the component address of the active first component.

8. A method as claimed in claim 6 wherein the component addresses conform to the Project50 standard.

9. An AV system comprising at least a first component (202, 204) connected to a second component (206) by a connection means, wherein the first component is operable to:
add an identifier to a signal in dependence on the first component being active;
send the signal to the second component; and wherein the second component is operable to:
receive from at least one first component a plurality of signals;
for each signal of the plurality of received signals:
analyse the signal for the presence of the identifier; and
where the identifier is present determine and store at least one parameter associated with the identifier; and
select a signal from the plurality of received signals in dependence on stored ones of the parameters.

10. An AV system as claimed in claim 9, wherein the first component is further operable to:
communicate to other components of the system a relevant parameter associated with the identifier; and wherein the second component is operable to:
acquire the relevant parameter at the second component; and
wherein the step of selecting a signal from the plurality of received signals is on the basis of a comparison of stored ones of the parameters and the relevant parameter.

11. A system as claimed in claim 9, wherein the connection means supports the sending of analogue AV signals.

12. A system as claimed in claim 11, wherein analogue AV signals comprise analogue audio via phono connector.

13. A system as claimed in claim 10, wherein the connection means comprises a bus (350) to support the communication of the relevant parameter.

14. A system as claimed in claim 13, wherein the bus is Scart/HDMI supporting Project50/CEC protocols.

15. A system as claimed in claim 13, wherein the identifier is communicated using the user data bits of the SP/DIF protocol.

16. A first component (400) for use in the system of claim 9 comprising:
a user interface (402) operable to receive user commands;
a source (406) of AV signals;
an output device (410) operable to:
add an identifier to at least one of the AV signals;
output the AV signals;
a processor (414) operable to:
instruct the output device to add the identifier in dependence on the first component being active.

17. A component as claimed in claim 16 further comprising:
a control interface (418) operable to send a relevant parameter associated with the identifier;
and wherein the processor (414) is further operable to:
instruct the control interface to send a relevant parameter associated with the identifier.

18. A second component (500) for use in the system of claim 9 comprising:
a switching matrix (502) operable to:
receive a plurality of signals;
select at least one of the signals;
output the at least one selected AV signals;
a store (510);
a processor (512) operable to:
analyse each signal of the plurality of received signals for the presence of an identifier;
where an identifier is present, determine and store at least one parameter associated with the identifier;
instruct the switching matrix to select a signal in dependence on the stored parameters.

19. A component as claimed in claim 18 further comprising:
a control interface (516) operable to receive a relevant parameter associated with the identifier;
and wherein the processor (512) is further operable to:
instruct the switching matrix to select a signal from the plurality of received signals on the basis of a comparison of the stored parameters and the relevant parameter.

20. A component as claimed in claim 16.

21. A component as claimed in claim 17 wherein the control interface supports the Project50/CEC protocol.

22. A component as claimed in claim 19, wherein the received signals are digital audio encoded using the SP/DIF protocol and the identifier is communicated using the user data bits of the SP/DIF protocol.

23. A record carrier comprising software operable to carry out the method of any of claim 1.

24. A software utility configured for carrying out the method steps as claimed in claim 1.

25. A component including a processor, said processor being directed in its operations by a software utility as claimed in claim 24.
